(19) United States
(12) Patent Application Publication
(10) Pub. No.: US 2003/0213339 A1
(43) Pub. Date: Nov. 20, 2003

(54) T-nut driver

(76) Inventor: James Vincent Bellanca, Mt. Pleasant, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/441,711

(22) Filed: May 20, 2003

Related U.S. Application Data
(60) Provisional application No. 60/361,468, filed on May 20, 2002.

(51) Int. Cl. B25B 13/00

(52) U.S. Cl. 81/52

(57) ABSTRACT

A rod shaped steel tool designed to aid in the installation of t-nuts. The T-Nut Driver has a tip 10 on which a t-nut is placed. There is an end 14 which is inserted into a pneumatic air hammer.

### CROSS-REFERENCE TO RELATED APPLICATIONS

This application claims the benefit of provisional application serial No. 60/361,468, filed May 20, 2002.

### TECHNICAL FIELD

This invention generally relates to fastening tools and more particularly relates to tools for installing t-nuts.

### BACKGROUND OF THE INVENTION

A t-nut is a common fastener used as an alternative to a washer and standard nut. It is common in many industries including the furniture, amusement, and artificial climbing wall industry. T-nuts are produced in many varieties but they all share a common design theme. Specifically, they all include a threaded barrel portion that terminates into a flange. The flange can include barbs (for securing the t-nut to a mounting surface) but barbs are not necessary in many applications. Traditionally t-nuts are installed in one of two ways: using a ordinary hammer or using a customized heavy duty pneumatic press. This has made the installation of t-nuts both time-consuming and costly, and often times resulted in incorrect installation. When using a hammer, it is very easy for the installer to misalign the barrel portion of the t-nut with a preexisting hole. This in turn makes it very probable that a mating bolt will cross-thread the t-bolt and/or push-out the t-nut from the preexisting hole. Installation with a hammer requires a great deal of physical effort. This can result in fatigue and then lead to improper installation. The invention of the pneumatic press has greatly reduced the physical effort and helped to eliminate poor installation. However, using a pneumatic press can be very expensive and has the drawback of not being portable. Typically, these presses are massive stationary units that only work with skinny board or rails, and only work with a special type of t-nut. Typically these units only work in a vertical manner.

### OBJECTS AND ADVANTAGES

Accordingly, several objects and advantages of the present invention include stronger installations through proper alignment, less operator fatigue, portability, and a greater compatibility with various brands and sizes of t-nuts. Due to the design of the T-Nut Driver, and the power of the pneumatic air hammer, the t-nuts are easily installed at the correct angle and depth. In addition, the T-Nut Driver can be used at any angle. Other objects and advantages include faster installation and a lower equipment cost.

### SUMMARY OF THE INVENTION

The T-Nut Driver aids in the efficient and proper installation of t-nuts. The T-Nut Driver reduces physical effort and yields a portable alternative to traditional methods of installation.

### BRIEF DESCRIPTION OF THE DRAWINGS

FIG. 1 is a side view of the T-Nut Driver.

FIG. 2 is a perspective view of the T-Nut Driver.

FIG. 3 is an environmental view of the T-Nut Driver in use.

### DETAILED DESCRIPTION OF THE INVENTION

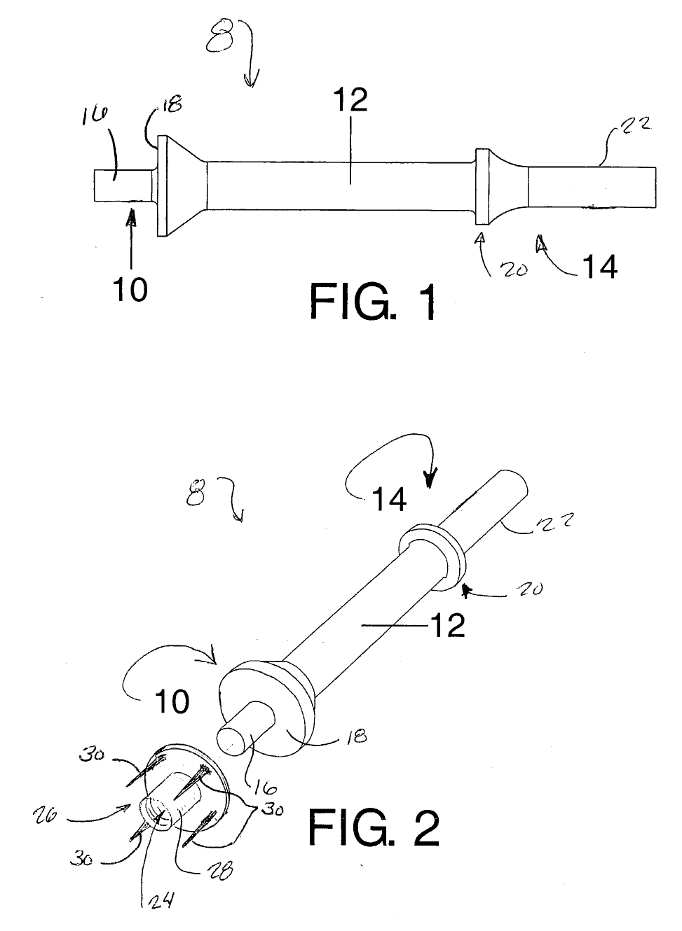

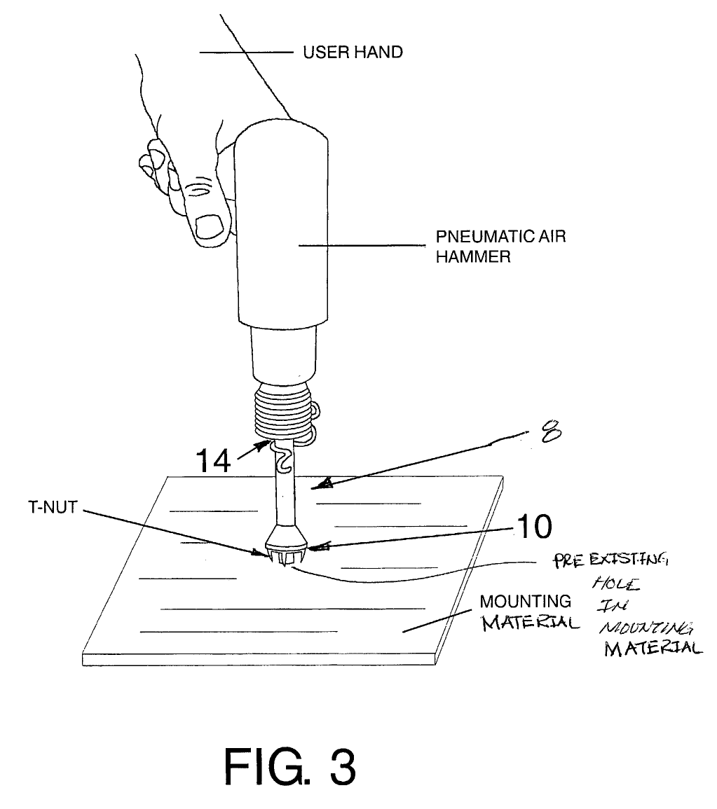

FIG. 1 shows a side view of the present invention 8. FIG. 2 shows a perspective view of the present invention 8. FIG. 3 shows an environmental view of the present invention in use. The drawing shows a user installing a t-nut using the present invention and a pneumatic air hammer. The preferred embodiment would be a high strength, hardened, tool grade steel such as A-1. However, the present invention could be manufactured from any suitable high strength steel.

The present invention includes body portion 12 which terminates into first and second end portions 10,14 respectively. First end portion 10 includes stem portion 16 and a shoulder portion 18. Stem 16 and shoulder 18 support the t-nut during installation. Second end 14 includes a raised surface 20 and a cylindrical stub 22. The combination of the retaining surface 20 and stub 22 facilitate attaching the present invention 8 to a pneumatic air hammer.

Operation of Invention

The manner of using the present invention is to first insert the second end 14 into a pneumatic air hammer and to affix thereto. The user then would place a t-nut onto the first end portion 10 such that stem 16 is received within barrel opening 24 of t-nut 26. The user would then align the barrel 28 with a pre-drilled hole placed in the mounting material to which the t-nut is to be joined. The t-nut is secured to the mounting material by means of a friction fit between the barrel 28 and the side walls of the preexisting hole, the frictional engagement between the t-nut barbs and the mounting material, or both. The user would then activate the air hammer which causes the shoulder 18 of the present invention to pound against a driving surface of the t-nut thereby driving the t-nut into the mounting material. Once the t-nut is properly inserted into the material, the user would then pull the present invention out from the properly installed t-nut.

Advantages

From the description above, advantages to the present invention become evident:

(a) The present invention provides near effortless installation by using the power of an air hammer to install the t-nut rather than human force. This results in greater efficiency and more consistent work.

(b) The present invention will install t-nuts more correctly thereby helping to eliminate problems such as cross-threading of the bolt and or t-nut, and reduced the likelihood of t-nut push out.

(c) The present invention provides a portable solution allowing installation on large surfaces at any angle.

(d) The present invention provides a low cost alternative to other machine installed options.

Conclusions, Ramifications, and Scope of Invention

The reader should see that the present invention offers better and faster installation of t-nuts. In addition, the present invention is so simple to use that even those with no experience will achieve excellent results.

The present invention can be made in a variety of sizes to accommodate various t-nuts and various air hammers. The tip 10 can be made in a variety of shaped and the end 14 can be made in any size necessary to adapt to any air hammer. The present invention can be made in any length to suit various needs. Thus the scope of the invention should be determined by the appended claims and their legal equivalents, rather than by the examples given.

Drawings—List of Reference Numerals

8 T-Nut Driver

10 first end portion

12 body

14 second end portion

16 stem

18 shoulder

20 raised surface

22 stub

24 barrel opening of 26

26 t-nut

28 barrel of 26

30 barbs of 26

I claim:

1. A t-nut driver, comprising:
a body portion which terminates into first and second end portions, wherein said first end portion includes a stem portion for engaging the interior barrel of a t-nut, and wherein said first surface further includes a shoulder, wherein said shoulder is effective for engaging a driving surface of a t-nut,
and wherein said second end portion includes a stub for insertion into a pneumatic hammer and a retaining surface for retaining said t-nut driver with said pneumatic hammer.

2. The t-nut driver of claim 1, wherein said body portion and said first and second end portions are fabricated from tool steel.
